(19) United States
(12) Patent Application Publication
(10) Pub. No.: US 2004/0006611 A1
(43) Pub. Date: Jan. 8, 2004

(54) Remote management system and method

(75) Inventor: Kyoung-hoon Yi, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/445,226

(22) Filed: May 27, 2003

(30) Foreign Application Priority Data
Jun. 20, 2002 (KR) 2002-34648

(51) Int. Cl. G06F 15/177

(52) U.S. Cl. 709/222; 709/223

(57) ABSTRACT

A remote management system including a remote management server, a data broadcasting apparatus, and a plurality of remote management target devices, and a remote management method are provided. The remote management server generates a job control command packet according to an area, in which remote management target devices execute a requested remote management job, and transmits the job control command packet to a data broadcasting apparatus when the requested remote management job is a common job to a plurality of remote management target devices. The data broadcasting apparatus receives the job control command packet from the remote management server, converts the job control command packet into broadcast data, and transmits the broadcast data to the plurality of remote management target devices through a broadcast channel. The remote management target devices restore a job control command included in the broadcast data and execute the requested job.

### CROSS-REFERENCE TO RELATED APPLICATIONS

This application claims the priority of Korean Patent Application No. 2002-34648, filed on Jun. 20, 2002, which is incorporated herein in its entirety by reference.

### BACKGROUND OF THE INVENTION

1. Field of the Invention

The present invention relates to remote management of network devices connected to a network, and more particularly, to a system and method for remotely managing network devices using a broadcast channel.

2. Description of the Related Art

With the spread of network technology, various types of network devices having a network function have been developed and spread. In particular, with the appearance of electric home appliances, such as televisions and refrigerators, having the network function, a home network system has been introduced. Such network devices can provide their own conditions and various kinds of user information to manufacturing companies or service companies through a network. Accordingly, the manufacturing companies apply remote management technology to the network devices in order to continuously obtain information regarding the products that they manufactured and sold and reducing incidental expenses such as expenses for after sales customer service.

FIG. 1 is a diagram of a conventional remote management system, which includes a remote management server 110, a network 120, and a plurality of remote management target devices 130 through 150.

The remote management server 110 operates according to a job control command, which is given by a server manager in order to remotely manage the plurality of remote management target devices 130 through 150 connected to the network 120, or a predetermined program.

The remote management target devices 130 through 150 are network devices that are remotely managed by the remote management server 110. Each of the remote management target devices 130 through 150 provides information on its conditions or executes a particular work in response to a job control command received from the remote management server 110.

The remote management server 110 includes a manager interface unit 111, a remote management controller 112, a device controller 113, a job table DB (DB) 114, a device registration DB 115, a communication unit 116, a device information processor 117, and a device information DB 118.

The manager interface unit 111 provides user interface for interaction with a manager. The remote management controller 112 receives a job control command from the manager through the manager interface unit 111, generates a job description relating to a job, which each of the remote management target devices 130 through 150 is to execute, and adds the job description to a job table, which is stored in the job table DB 114 for each remote management target devices 130, 140, or 150. In addition, the remote management controller 112 controls the device controller 113 to generate a job control command packet with reference to the job description stored in the job table DB 114.

The device controller 113 generates job control command packets for controlling the jobs of the remote management target devices 130 through 150 under the authority of the remote management controller 112 to directly control the remote management target devices 130 through 150.

The job table DB 114 stores a plurality of job tables describing a job that each of the remote management target devices 130 through 150 is to execute.

The information registration DB 115 stores information on the positions of the remote management target devices 130 through 150.

The communication unit 116 communicates with the remote management target devices 130 through 150 through the network 120. The communication unit 116 is not dependent on a particular network technique. For example, when the network 120 is Ethernet, the communication unit 116 conceptually includes a communication protocol such as a TCP/IP (Transmission Control Protocol/Internet Protocol) and physical layers.

The device information processor 117 is controlled by the remote management controller 112 to extract necessary information from the information on the remote management target devices 130 through 150, which is stored in the device information DB 118, or process the information stored in the device information DB 118.

The device information DB 118 stores update information on each of the remote management target devices 130 through 150.

Meanwhile, the remote management target device 130 includes a communication unit 131, a remote management corresponding unit 133, a job execution unit 135, and an information DB 137.

The communication unit 131 is a separate device for communication with the communication unit 116 of the remote management server 110. The remote management corresponding unit 133 analyzes a received job control command packet so that an appropriate job can be executed.

The job execution unit 135 executes a job corresponding to the received job control command packet when the job control command packet requests a particular operation or control.

The information DB 137 stores update information on the remote management target device 130. When the received job control command packet requests the update information on the remote management target device 130, the remote management corresponding unit 133 reads the update information, makes it into a report packet, and transmits the report packet to the remote management server 110.

In a conventional network management method, for example, using a simple network management protocol (SNMP), a manager provides position information of remote management target devices to a remote management server so that the remote management server can know the positions of the remote management target devices in advance, or the remote management server detects the positions of the remote management target devices using an appropriate network technique taking into account that the remote management target devices belong to a local network within the same area.

When checking information on each remote management target device 130, 140, or 150, the remote management controller 112 fetches the information stored in the device information DB 118 through the device information processor 117 and checks the content of the information. However, when the stored information is not valid, or when it is necessary to control each of the remote management target devices 130 through 150 in real time, the remote management controller 112 requests each remote management target device 130, 140, or 150 to send information or to perform an operation and receives the result of the request through the device controller 113.

Meanwhile, the remote management controller 112 makes a list of desired jobs except for real-time controls, registers the list in the job table DB 114, and informs the device controller 113 of the registration of the list.

The device controller 113 determines when and how to perform each of the jobs registered in the job table DB 114 according to the predetermined program. For example, when it is necessary to execute a job, the device controller 113 reads the position information of the remote management target device 130 from the device registration DB 115, checks whether the remote management target device 130 can perform communication, reads the content of the job to be executed from the job table DB 114, converts the content of the job into a job control command packet, and transmits the job control command packet to the remote management target device 130 through the communication unit 116.

In the remote management target device 130, the remote management corresponding unit 133 receives the job control command packet through the communication unit 131 and analyzes the job control command packet. If the job control command packet requests update information of the remote management target device 130, the remote management corresponding unit 133 reads the update information from the information DB 137, converts the update information into a report packet, and transmits the report packet to the device controller 113. If the job control command packet requests a particular control or operation, the remote management corresponding unit 133 controls the job execution unit 135 to execute the control or operation, converts the result of execution into a report packet, and transmits the report packet to the device controller 113.

In response to the report packet, the device controller 113 requests the device information processor 117 to update a corresponding entry within the device information DB 118, and the content of the update is reported to the remote management controller 112.

Such conventional technology applies to network devices installed within a limited area, so it is not proper to an environment in which products launched to meet a new market such as a home network are used. For example, actually, it is difficult to detect positions, at which all of the sold products are to be installed, in advance, and it is difficult to assign an address area, which each product can externally access through a network. Moreover, since most of the network server companies assign variable addresses changing at each connection instead of fixed addresses, it takes a large amount of time and expense to detect the addresses of devices spread in a wide area using an existing model and to design a server to give proper job control commands to control the network devices.

In addition, except for a rare case where an error occurs, the purpose of remote management is achieved by log information and state information, which are generated by most of the network devices during operation. For the log or state information needed during normal operation and job control commands given by a server manager, almost the same operations are performed on individual network devices, so it is redundant for a remote management server to individually give job control commands to the network devices, which results in considerably high overhead. In other words, even if the same kind of information or operation is requested from the network devices, the remote management server needs to transmit the same information as many times as the number of network devices.

### SUMMARY OF THE INVENTION

The present invention provides a remote management server for generating a job control command packet and transmitting the job control command packet to a data broadcasting apparatus when the requested job is common to the remote management target devices, and a remote management method performed by the remote management server.

The present invention also provides a data broadcasting apparatus for receiving a job control command packet from a remote management server, converting the job control command packet into broadcast data and transmitting the broadcast data to a plurality of remote management target devices through a broadcast channel, and a remote management method using the data broadcasting apparatus.

The present invention also provides a remote management target device for receiving a job control command included in broadcast data and executing a requested job, and a method thereof.

According to an aspect of the present invention, there is provided a remote management server connected to a plurality of remote management target devices through a network. The remote management server includes a job table database, which stores a plurality of job tables in which a plurality of jobs to be executed by the remote management target devices are recorded; a remote management controller, which receives a job request signal for one or more remote management target devices, generates a first job description describing the content of a job corresponding to the job request signal and a first control signal when the job is common to a plurality of remote management target devices, generates a second job description describing the content of the job and a second control signal when the job needs to be independently executed by the individual remote management target devices, and stores the first job description and the second job description in the job table database; a common job controller, which in response to the first control signal from the remote management controller, reads the content of the job described in the first job description from the job table database and generates a first job control command packet; and a device controller, which in response to the second control signal from the remote management controller, reads the content of the job described in the second job description from the job table database and generates a second job control command packet.

According to another aspect of the present invention, there is provided a remote management method performed by a remote management server connected to a plurality of remote management target devices through a network. The remote management method includes storing a plurality of job tables, in which a plurality of jobs to be executed by the remote management target devices are recorded, in a job table database; receiving a job request signal for one or more remote management target devices, generating a first job description describing the content of a job corresponding to the job request signal and a first control signal when the job is common to a plurality of remote management target devices, generating a second job description describing the content of the job and a second control signal when the job needs to be independently executed by the individual remote management target devices, and storing the first job description and the second job description in the job table database; in response to the first control signal, reading the content of the job described in the first job description from the job table database and generating a first job control command packet; and in response to the second control signal, reading the content of the job described in the second job description from the job table database and generating a second job control command packet.

According to still another aspect of the present invention, there is provided a data broadcasting apparatus including a communication unit receiving a job control command packet, which is transmitted from a remote management server through a network in order to control a job of a plurality of remote management target devices; a remote management broadcast data generator, which receives the job control command packet from the communication unit and generates broadcast data including a job control command included in the job control command packet; and a broadcast data transmitter receiving and transmitting the broadcast data from the remote management broadcast data generator.

According to still another aspect of the present invention, there is provided a remote management method using a data broadcasting apparatus. The remote management method includes receiving a job control command packet, which is transmitted from a remote management server through a network in order to control a job of a plurality of remote management target devices; receiving the job control command packet and generating broadcast data including a job control command included in the job control command packet; and receiving and transmitting the broadcast data.

According to still another aspect of the present invention, there is provided a remote management target device including a broadcast data receiver receiving broadcast data transmitted from a data broadcasting apparatus, the broadcast data including a job control command for remote management; a broadcast data decoder, which receives the broadcast data from the broadcast data receiver, extracts a first job control command packet from the broadcast data, and outputs the extracted first job control command packet; and a remote management corresponding unit, which receives the first job control command packet from the broadcast data decoder and analyzes the first job control command packet.

According to still another aspect of the present invention, there is provided a remote management method performed by a remote management target device. The remote management method includes receiving broadcast data transmitted from a data broadcasting apparatus, the broadcast data including a job control command for remote management; receiving the broadcast data, extracting a first job control command packet from the broadcast data, and outputting the extracted first job control command packet; and receiving and analyzing the first job control command packet.

### BRIEF DESCRIPTION OF THE DRAWINGS

The above features and advantages of the present invention will become more apparent by describing in detail preferred embodiments thereof with reference to the attached drawings in which:

FIG. 1 is a diagram of a conventional remote management system;

FIG. 2 is a conceptual diagram of a remote management system using a broadcast channel according to the present invention;

FIG. 3 is a block diagram of a remote management server according to an embodiment of the present invention;

FIGS. 4A and 4B are diagrams for explaining operations related to a job table database (DB) shown in FIG. 3;

FIG. 5 is a block diagram of a data broadcasting apparatus according to an embodiment of the present invention;

FIG. 6 is a block diagram of a remote management target device according to an embodiment of the present invention;

FIG. 7 is a flowchart of the operations of a remote management controller shown in FIG. 3;

FIG. 8 is a flowchart of the operations of a common job controller shown in FIG. 3;

FIG. 9 is a flowchart of the operations of a device controller shown in FIG. 3;

FIG. 10 is a flowchart of a remote management method using a data broadcasting apparatus according to an embodiment of the present invention; and

FIG. 11 is a flowchart of a remote management method performed by a remote management target device according to an embodiment of the present invention.

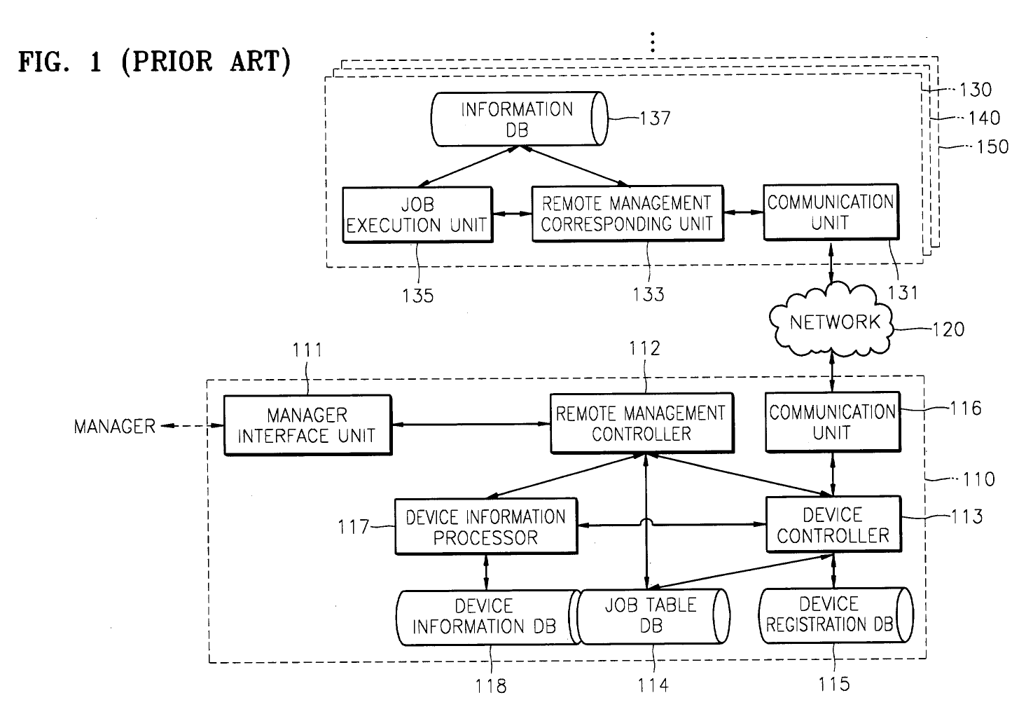

### DETAILED DESCRIPTION OF THE INVENTION

Terms used in the present specification and claims should be construed as having meanings and concept conforming to the technological ideas of the present invention, based on the principle that inventors can appropriately define the concept in terms to explain optimally the invention.

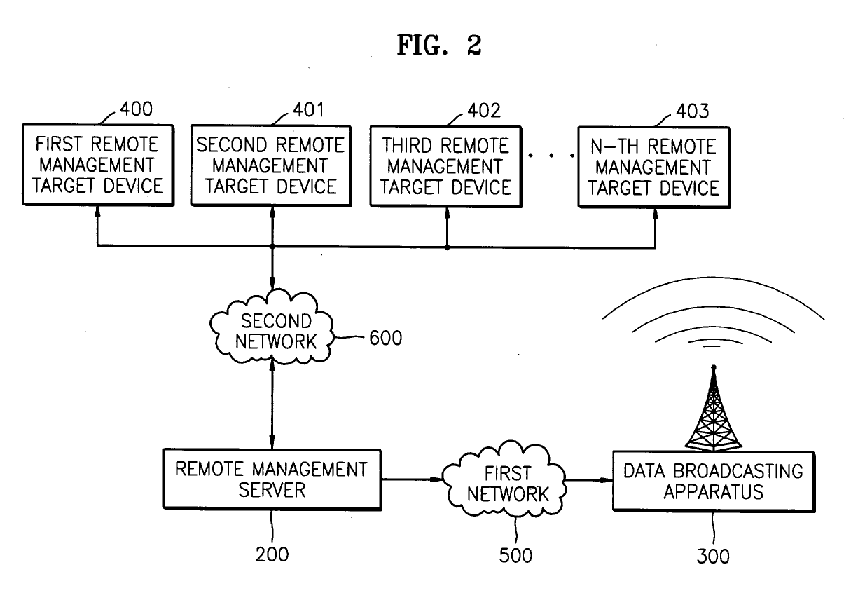

Referring to FIG. 2, a remote management system includes a remote management server 200, a data broadcasting apparatus 300, first through N-th remote management target devices 400 through 403, a first network 500, and a second network 600.

In response to a remote management job request input by a manager, the remote management server 200 determines whether the remote management job request is for a common job to a plurality of remote management target devices or for a job needing one-to-one control. If it is determined that a common job is requested, the remote management server 200 generates a job control command packet corresponding to the remote management job request and transmits the job control command packet to the data broadcasting apparatus 300 through the first network 500. If it is determined that a job needing one-to-one control is requested, the remote management server 200 generates a job control command packet corresponding to the remote management jot request and transmits the job control command packet to each of the remote management target devices through the second network 600.

The data broadcasting apparatus 300 receives the job control command packet from the remote management server 200 through the first network 500, converts the job control command packet into broadcast data, and transmits the broadcast data through a broadcast channel.

When the job requested by the manager is common to the first through N-th remote management target devices 400 through 403, the first through Nth remote management target devices 400 through 403 receive a job control command included in the broadcast data transmitted from the data broadcasting apparatus 300 and execute a corresponding job. When the job requested by the manager needs one-to-one control of the remote management server 200, each of the first through N-th remote management target devices 400 through 403 receives a job control command through the second network 600 and executes a corresponding job.

The first network 500 connects the remote management server 200 to the data broadcasting apparatus 300, and the second network 600 connects the remote management server 200 to the plurality of remote management target devices 400 through 403. The first network 500 and the second network 600 may be realized as, for example, Ethernet and may or may not be the same.

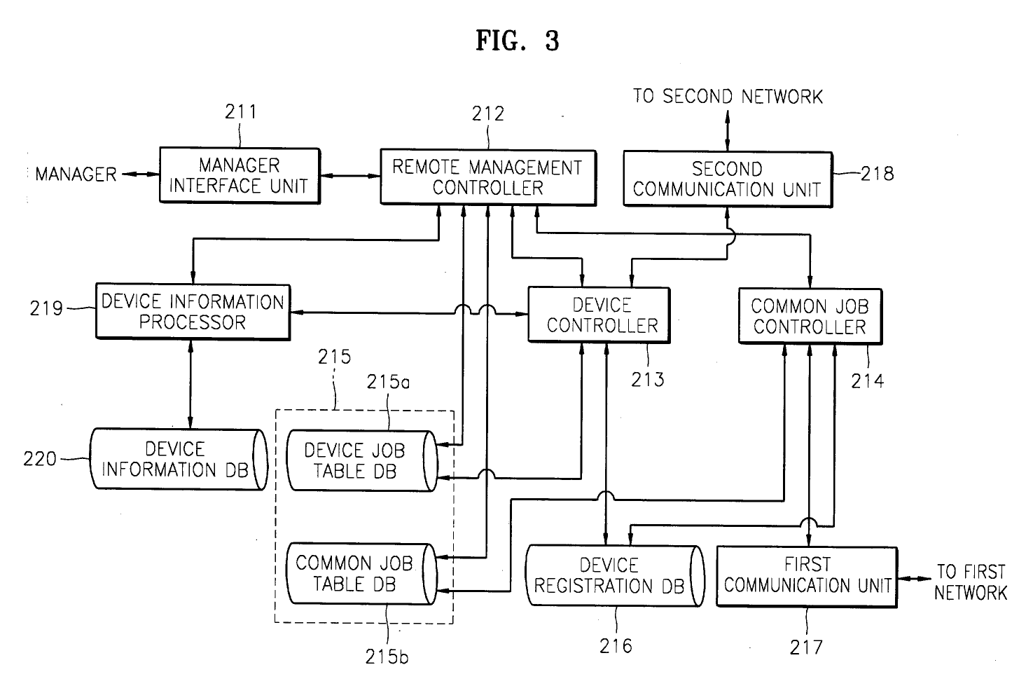

Hereinafter, the operation and structure of a remote management server and a remote management method performed by the remote management server according to an embodiment of the present invention will be described in detail with reference to FIGS. 3 through 4B and 7 through 9.

FIG. 3 is a block diagram of a remote management server according to an embodiment of the present invention. The remote management server includes a manager interface unit 211, a remote management controller 212, a device controller 213, a common job controller 214, a job table database (DB) 215, a device registration DB 216, a first communication unit 217, a second communication unit 218, a device information processor 219, and a device information DB 220. The job table DB 215 includes a device job table DB 215a and a common job table DB 215b.

The manager interface unit 211 provides user interface for interaction with a manager. The remote management controller 212 receives a job control command from the manager through the manager interface unit 211, generates a job description relating to a job, which each of the remote management target devices 400 through 403 shown in FIG. 2 is to execute, and adds the job description to a job table stored in the job table DB 215. In addition, the remote management controller 212 controls the device controller 213 and the common job controller 214 to generate a job control command packet with reference to the job description stored in the job table DB 215.

The device controller 213 generates job control command packets for controlling the jobs of the remote management target devices 400 through 403 under the authority of the remote management controller 212 to directly control the remote management target devices 400 through 403.

The common job controller 214 reads the job description stored in the common job table DB 215b in response to a job execution request of the remote management controller 212 and generates a job control command packet.

The job table DB 215 stores a plurality of job tables describing jobs that each of the remote management target devices 400 through 403 is to execute. The job table DB 215 is composed of a device job table DB 215a storing device-based job tables describing jobs which each of the remote management target devices 400 through 403 is to execute and the common job table DB 215b storing device class-based job tables describing jobs which the remote management target devices 400 through 403 belonging to the same class execute commonly.

The information registration DB 216 stores information on the positions of the remote management target devices 400 through 403.

The first communication unit 217 transmits the job control command packet generated by the common job controller 214 to the data broadcasting apparatus 300 through the first network 500 shown in FIG. 2. The second communication unit 218 transmits the job control command packet generated by the device controller 213 to the plurality of remote management target devices 400 through 403 through the second network 600 shown in FIG. 2 and receives data, such as a report packet, transmitted from the plurality of remote management target devices 400 through 403.

The device information processor 219 is controlled by the remote management controller 212 to extract necessary information from the information on the remote management target devices 400 through 403, which is stored in the device information DB 220, or process the information stored in the device information DB 220.

The device information DB 220 stores update information on each of the remote management target devices 400 through 403.

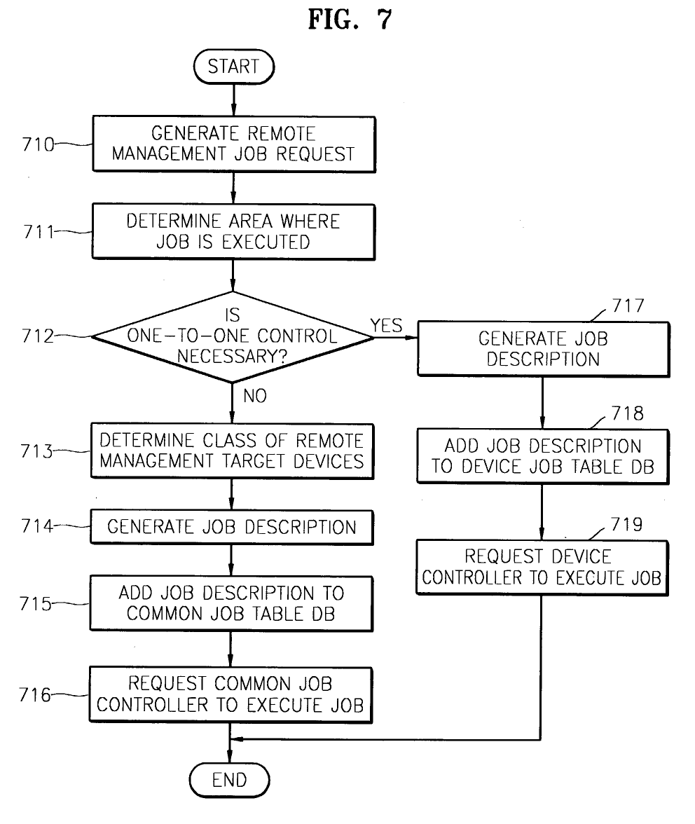

FIG. 7 is a flowchart of the operations of the remote management controller 212. The operations of the remote management controller 212 will be described in detail with reference to FIG. 7.

A manager generates a remote management job request through the manager interface unit 211 in step 710. The remote management controller 212 receives the remote management job request and determines a number of remote management target devices, to which the remote management job request is applied, in step 711. It is determined whether the remote management server 200 needs to control the remote management target devices one to one in step 712. If it is determined that the remote management server 200 needs to control the remote management target devices one to one, the remote management controller 212 generates a job description corresponding to the remote management job request in step 717. After operation 717, the remote management controller 212 adds the job description to job tables regarding the remote management target devices to which the remote management job request is applied among a plurality of job tables regarding a plurality of remote management target devices, which are stored in the device job table DB 215a, in step 718. The remote management controller 212 requests the device controller 213 to executes a job corresponding to the remote management job request in step 719.

If it is determined that the remote management server 200 does not need to control the remote management target devices one to one, that is, if it is determined that the remote management job request is for a common job to the remote management target devices, the remote management controller 212 determines a class, under which the remote management target devices to which the remote management job request is applied fall, in step 713. Here, the class is defined based on the model, manufacturing date, and geographical position of a remote management target device. Accordingly, it is possible to give a job command to update, by way of illustrative example, the firmware of particular model network refrigerators and execute updating.

After operation 713, the remote management controller 212 generates a job description corresponding to the remote management job request in step 714. The remote management controller 212 adds the generated job description to a common job table corresponding to the determined class in common job table DB 215b in step 715. The remote management controller 212 requests the common job controller 214 to execute a job corresponding to the remote management job request in step 716.

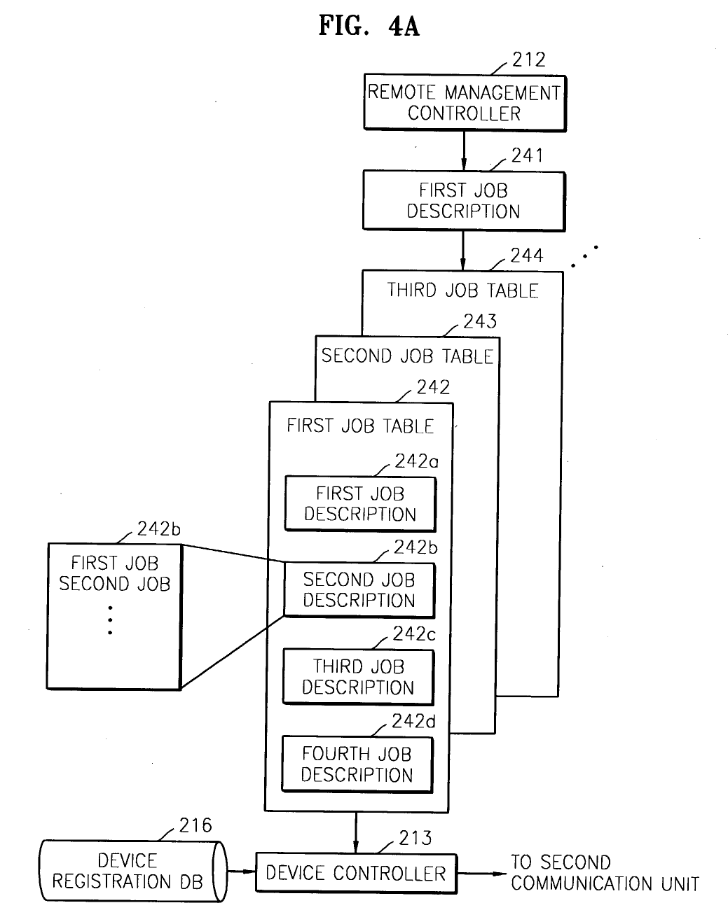

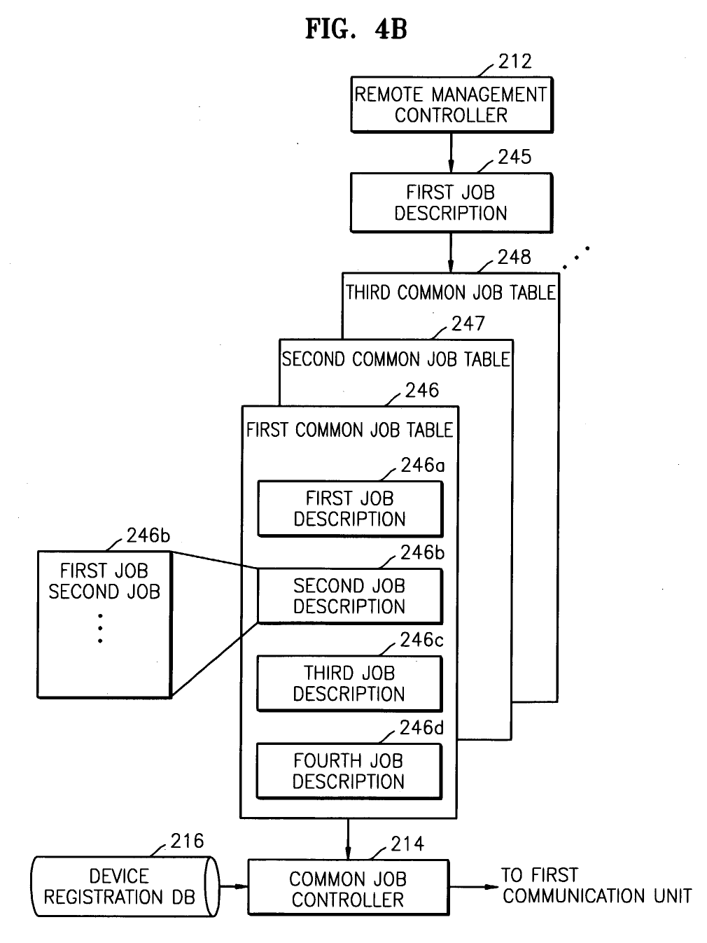

FIGS. 4A and 4B are diagrams for explaining operations related to the job table DB 215. FIG. 4A is a diagram for explaining an operation related to the device job table DB 215a. FIG. 4A illustrates operations 717 through 719. The device job table DB 215a is composed of a plurality of job tables, i.e., first through third job tables 242 through 244. Each of the job tables 242 through 244 includes a job description of jobs to be executed by a corresponding remote management target device. Referring to FIG. 4A, the first job table 242 includes a plurality of job descriptions 242a through 242d. Each of the job descriptions 242a through 242d is composed of a plurality of jobs. A first job description 241, which is generated by the remote management controller 212, is added to job tables corresponding to a plurality of remote management target devices that will execute a job described in the first job description 241. Here, the first job description 242a in the first job table 242 is the same as the first job description 241 generated by the remote management controller 212.

FIG. 4B is a diagram for explaining operations related with the common job table DB 215b. FIG. 4B illustrates operations 714 through 716. The common job table DB 215b is composed of a plurality of common job tables, i.e., first through third common job tables 246 through 248. Each of the common job tables 246 through 248 includes a job description of jobs to be commonly executed by remote management target devices falling under a corresponding class. Referring to FIG. 4B, the first common job table 246 includes a plurality of job descriptions 246a through 246d. Each of the job descriptions 246a through 246d is composed of a plurality of jobs. A first job description 245, which is generated by the remote management controller 212, is added to a common job table corresponding to the class of remote management target devices that will execute a job described in the first job description 245. Here, the first job description 246a in the first common job table 246 is the same as the first job description 245 generated by the remote management controller 212.

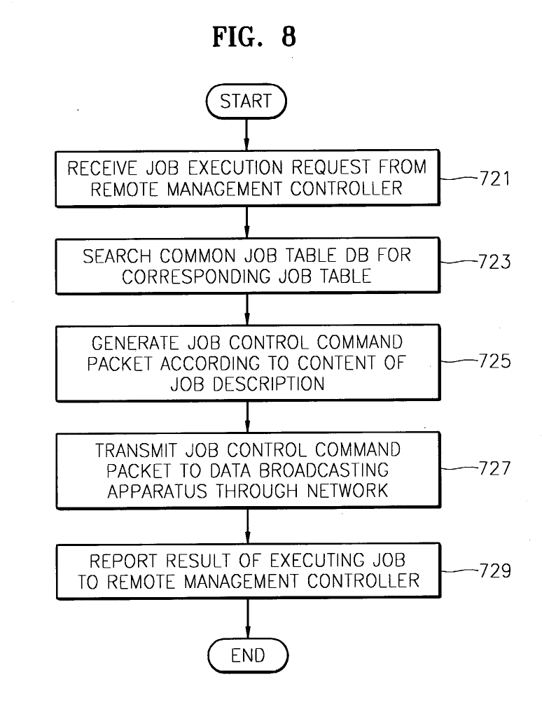

FIG. 8 is a flowchart of the operations of the common job controller 214. The operations of the common job controller 214 will be described in detail with reference to FIG. 8.

The common job controller 214 receives a signal requesting to execute a particular job from the remote management controller 212 in step 721. The common job controller 214 searches the common job table DB 215b for a corresponding common job table with reference to the received signal in step 723.

The common job controller 214 generates a job control command packet according to the content of a job description in the searched common job table in step 725. Meanwhile, the common job controller 214 can embed position information of the remote management server 200 into the job control command packet. The position information of the remote management server 200 embedded into the job control command packet is transmitted to remote management target devices through the data broadcasting apparatus 300 so that the remote management target devices can easily recognize the position of the remote management server 200.

The common job controller 214 transmits the job control command packet to the first communication unit 217 so that the job control command packet is transmitted to the data broadcasting apparatus 300 through the first network 500 in step 727. The common job controller 214 reports the result of executing the job to the remote management controller 212 in step 729.

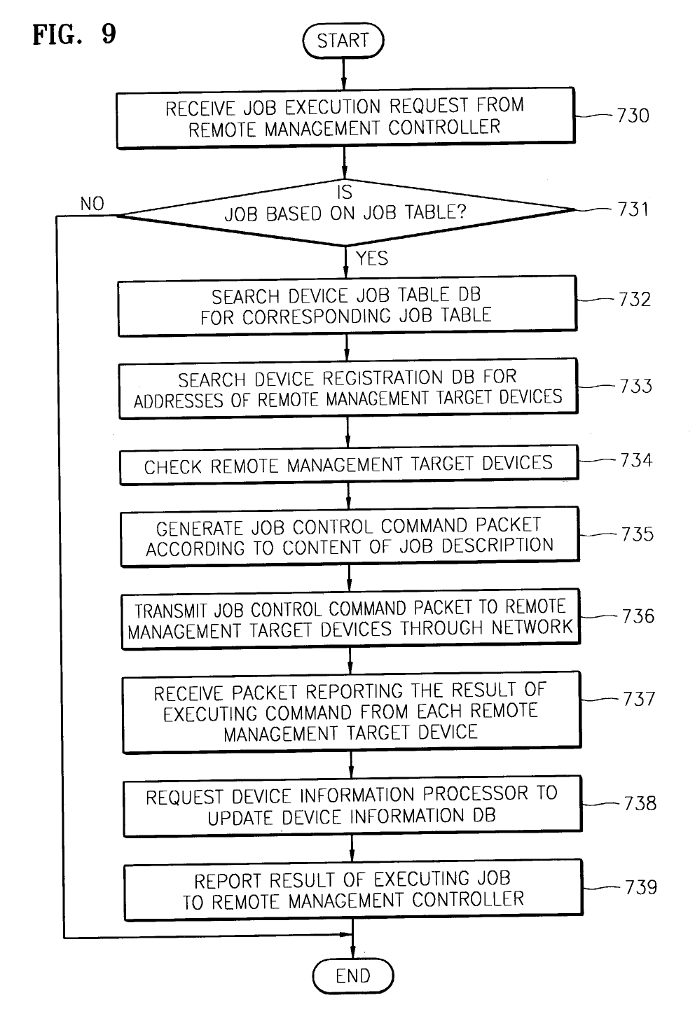

FIG. 9 is a flowchart of the operations of the device controller 213. The operations of the device controller 213 will be described in detail with reference to FIG. 9.

The device controller 213 receives a signal requesting to execute a particular job from the remote management controller 212 in step 730. The device controller 213 determines whether the requested job is based on a job table in step 731. If the requested job is based on a job table, the device controller 213 searches the device job table DB 215a for a corresponding job table with reference to the received signal in step 732. The device controller 213 searches the device registration DB 216 for the addresses of remote management target devices, which will execute a job, in step 733. Next, the device controller 213 transmits a checking signal to the remote management target devices through the second communication unit 217 to check whether the remote management target devices can perform communication and whether the addresses are correct in step 734. Next, the device controller 213 generates a job control command packet according to the content of a job description in the searched job table in step 735. The device controller 213 transmits the job control command packet to the remote management target devices through the second network 600 in step 736. The device controller 213 receives a packet reporting the result of executing a command from each of the remote management target devices through the second communication unit 218 in step 737. The device controller 213 requests the device information processor 219 to update the device information DB 220 with update information of each remote management target device, which is included in each of the received reporting packets, in step 738. The device controller 213 reports the result of executing a job to the remote management controller 212 in step 739.

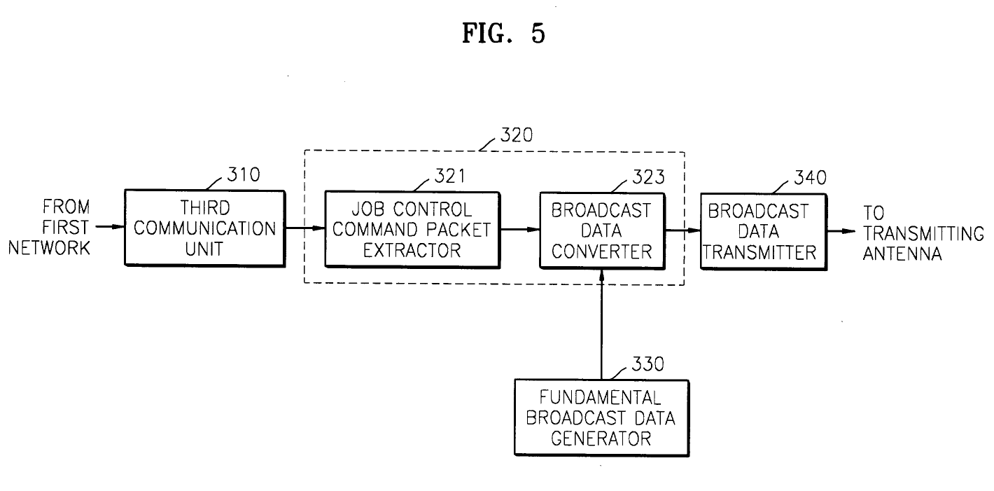

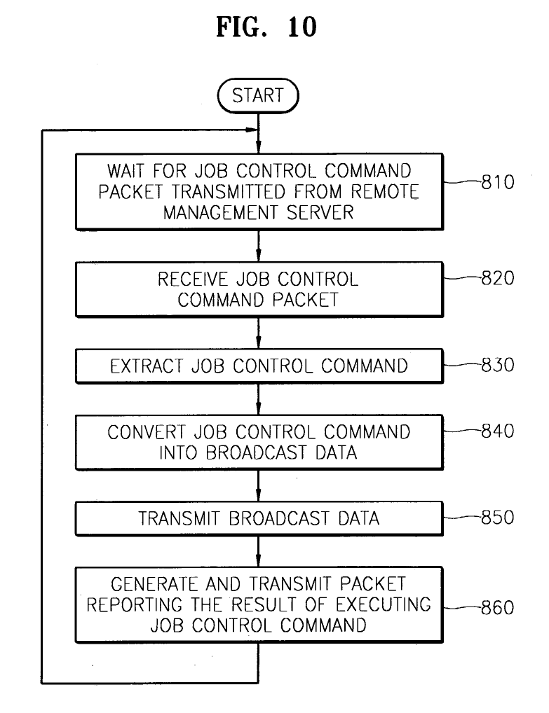

Hereinafter, a data broadcasting apparatus and a remote management method using the same according to an embodiment of the present invention will be described in detail with reference to FIGS. 5 and 10.

FIG. 5 is a block diagram of a data broadcasting apparatus according to an embodiment of the present invention. The data broadcasting apparatus includes a third communication unit 310, a remote management broadcast data generator 320, a fundamental broadcast data generator 330, and a broadcast data transmitter 340. The remote management broadcast data generator 320 includes a job control command packet extractor 321 and a broadcast data converter 323.

FIG. 10 is a flowchart of a remote management method using a data broadcasting apparatus according to an embodiment of the present invention. The data broadcasting apparatus 300 waits for a job control command packet transmitted from the remote management server 200 in step 810. If the job control command packet is transmitted from the remote management server 200, the third communication unit 310 receives the job control command packet in step 820.

The job control command packet extractor 321 extracts a job control command from the received job control command packet in step 830. Meanwhile, the job control command packet extractor 321 can embed position information of the remote management server 200, which is stored therein in advance, into the extract job control command. The position information of the remote management server 200 embedded into the job control command is transmitted to remote management target devices through the data broadcasting apparatus 300 so that the remote management target devices can easily recognize the position of the remote management server 200.

The broadcast data converter 323 receives the job control command and fundamental data, which is generated by the fundamental broadcast data generator 320, and convert the job control command and the fundamental data into broadcast data in step 840. The broadcast data transmitter 340 transmits the broadcast data to a broadcast data transmitting unit such as a transmitting antenna (not shown) in step 850. Each of the remote management target devices receives the broadcast data including the job control command, executes the job control command, generates a packet reporting the result of execution, and transmits the packet to the remote management server 200 through the second network 600 in step 860.

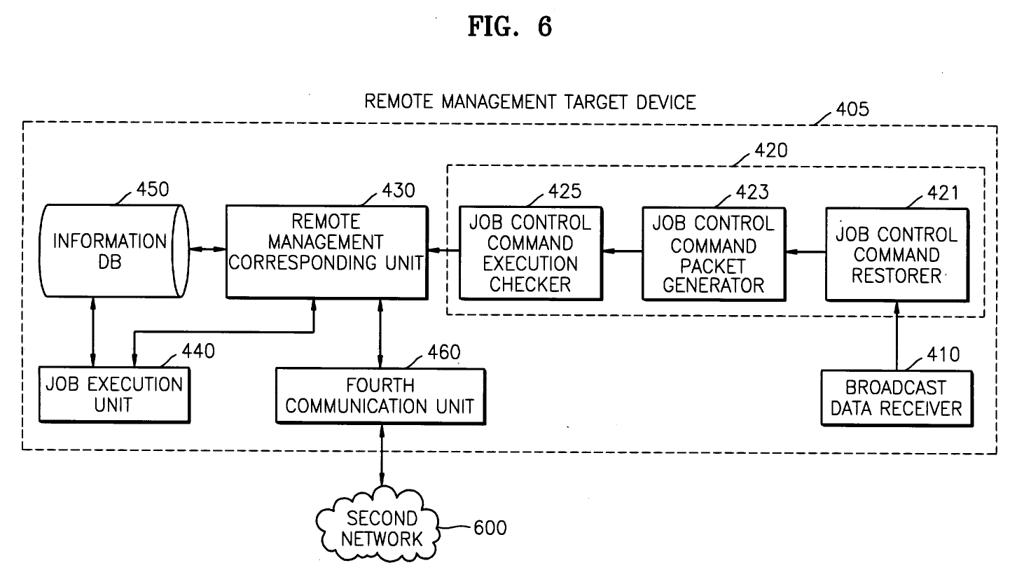

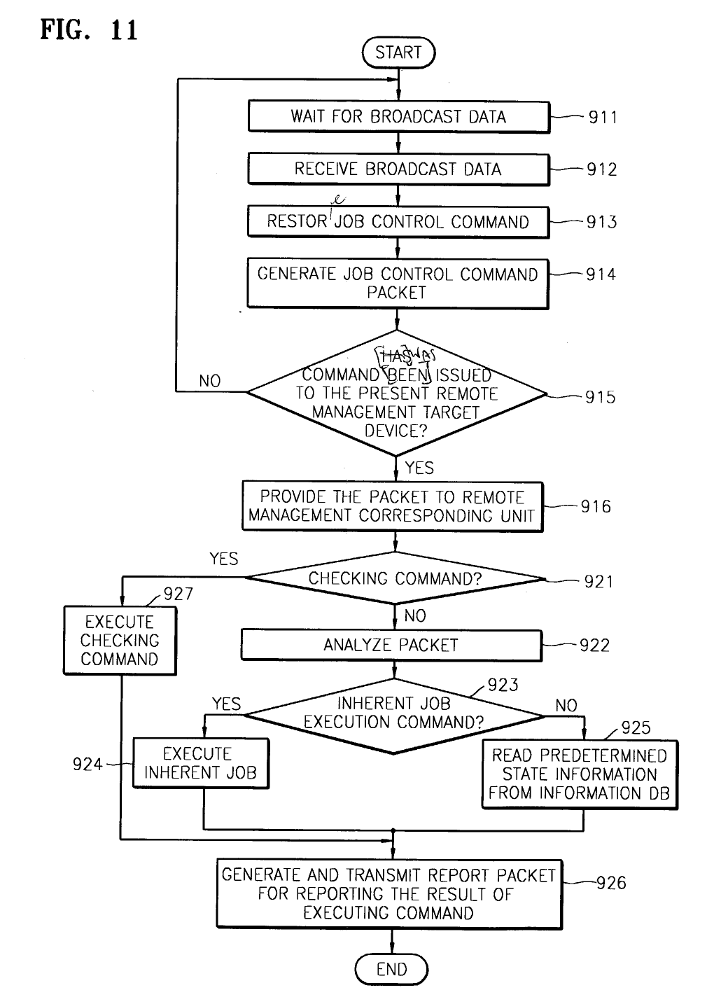

Hereinafter, a remote management target device and a remote management method performed by the same according to an embodiment of the present invention will be described in detail with reference to FIGS. 6 and 11.

FIG. 6 is a block diagram of a remote management target device 405 according to an embodiment of the present invention. The remote management target device 405 includes a broadcast data receiver 410, a broadcast data decoder 420, a remote management corresponding unit 430, a job execution unit 440, an information DB 450, and a fourth communication unit 460. The broadcast data decoder 420 includes a job control command restorer 421, a job control command packet generator 423, and a job control command execution checker 425.

FIG. 11 is a flowchart of a remote management method performed by the remote management target device 405 according to an embodiment of the present invention. The remote management target device 405 waits for broadcast data in step 911 and receives the broadcast data through the broadcast data receiver 410 in step 912. The job control command restorer 421 extracts and restores a job control command, which is transmitted from the remote management server 200, from the received broadcast data in step 913. The job control command packet generator 423 receives the restored job control command and generates a job control command packet having a data format, which the remote management target device 405 can process, in step 914.

The job control command execution checker 425 analyzes the job control command packet and checks whether the job control command included in the job control command packet was issued to the remote management target device 405 in step 915. The job control command transmitted from the data broadcast apparatus 300 can be received by every remote management target device 405 having the broadcast data receiver 410, so a procedure in which the job control command execution checker 425 checks whether the job control command was issued to the remote management target device 405 is required.

If it is determined that the job control command has been issued to the present remote management target device 405, the job control command execution checker 425 provides the job control command packet to the remote management corresponding unit 430 in step 916.

The remote management corresponding unit 430 determines whether a job control command packet input from the job control command execution checker 425 is a checking command in step 921. Here, the checking command indicates the checking signal generated in step 734 shown in FIG. 9. In other words, the checking command is transmitted from the device controller 213 of the remote management server 200 through the data broadcasting apparatus 300 in order to check whether remote management target devices to execute a job can communicate with the remote management server 200 and whether the addresses of the remote management target devices are correct.

Meanwhile, the remote management corresponding unit 430 receives a job control command packet transmitted from the remote management server 200 through the fourth communication unit 460. The job control command packet received through the fourth communication unit 460 is a job control command packet that is directly transmitted from the remote management server 200 through the second network 600 according a to one-to-one control method. The job control command packet received through the fourth communication unit 460 is processed in steps 921 through 926.

On the other hand, if the job control command packet is not the checking command, the remote management corresponding unit 430 analyzes the job control command packet in step 922. After operation 922, the remote management corresponding unit 430 determines whether the job control command packet commands to execute an inherent job in step 923.

If the job control command packet commands execution of an inherent job, the remote management corresponding unit 430 controls the job execution unit 440 to execute a predetermined inherent job in step 924. If the job control command packet does not command execution of an inherent job but requests update state information, the remote management corresponding unit 430 reads predetermined state information from the information DB 450 in step 925.

After operation 924, 925, or 927, the remote management corresponding unit 430 generates a report packet for reporting the result of executing a command and transmits the report packet to the second network 600 through the fourth communication unit 460 in step 926.

The present invention can be realized as code recorded on a computer readable recording medium which can be read by a computer. The computer readable recording medium may be any type on which data readable by a computer system or data processor can be recorded, for example, a ROM, a RAM, a CD-ROM, a magnetic tape, a floppy disc, an optical data storage device, firmware, hardware, circuit board, control card, fixed medium or other media suitable to carry out the purposes of the present invention. The present invention can also be realized as carrier waves (for example, transmitted through Internet). Alternatively, computer readable recording media may be distributed among computer systems or data processors connected through a network so that the present invention can be realized as code stored on the recording media and can be read and executed in the computers or data processors.

As described above, a remote management server according to the present invention generates a job control command packet and transmits the job control command packet to a data broadcasting apparatus when the requested remote management job is a common job to a plurality of remote management target devices. The data broadcasting apparatus receives the job control command packet from the remote management server, converts the job control command packet into broadcast data, and transmits the broadcast data to the plurality of remote management target devices through one or more broadcast channel or channels. The remote management target devices restore a job control command included in the broadcast data and execute the requested job. Accordingly, the remote management server does not need repeatedly to issue the same job request to the individual remote management target devices, thus decreasing the load of the remote management server. In addition, position information of the remote management server can be easily provided to every remote management target device through the broadcast channel, and the expenses and time for the remote management of remote management target devices can be decreased.

What is claimed is:

1. A remote management server connected to a plurality of remote management target devices through a network, the remote management server comprising:
a job table database configured to store a plurality of job tables in which a plurality of jobs to be executed by one or more of the plurality of remote management target devices are recorded;
a remote management controller configured to receive a job request signal for said one or more of the plurality of remote management target devices, to generate, when the job is common to a class of the plurality of remote management target devices, a first job description describing the content of a job corresponding to the job request signal and a first control signal, to generate, when the job is to be executed individually by one or more remote management target devices of the plurality of remote management target devices, a second job description describing the content of the job and a second control signal, and to store the first job description and the second job description in the job table database;
a common job controller configured to read, in response to the first control signal from the remote management controller, the content of the job described in the first job description from the job table database and to generate a first job control command packet; and
a device controller configured to read, in response to the second control signal from the remote management controller, the content of the job described in the second job description from the job table database and to generate a second job control command packet.

2. The remote management server of claim 1, wherein the job table database comprises:
a common job table database storing a plurality of first job descriptions; and
a device job table database storing a plurality of second job descriptions.

3. The remote management server of claim 1, wherein the remote management controller generates the first job description and the first control signal according to the class of the plurality of remote management target devices.

4. The remote management server of claim 1, wherein the common job controller embeds position information of the remote management server into the first job control command packet.

5. The remote management server of claim 1, wherein a job control command written in the first job control command packet is a current address checking command, which commands each member of the class of the plurality of remote management target devices to report its current network address.

6. The remote management server of claim 1, further comprising a first communication unit connected to the common job controller, the first communication unit configured to transmit the first job control command packet through the network to a data broadcast apparatus.

7. The remote management server of claim 1, further comprising:
a device registration database configured to store network addresses of the plurality of remote management target devices; and
a second communication unit connected to the device controller, the second communication unit configured to transmit the second job control command packet through a second network to at least one remote management target device, of the plurality of remote management target devices, requested to execute the job,
wherein the device controller transmits the second job control command packet to the at least one remote management target device through the second communication unit with reference to the network addresses of the plurality of remote management target devices stored in the device registration database.

8. The remote management server of claim 1, wherein the class of remote management target devices is defined by one selected from the group consisting of type, manufacturing date, and geographical position information of each remote management target device.

9. A data broadcasting apparatus comprising:
a communication unit configured to receive a job control command packet to control a job for a class of a plurality of remote management target devices, the job control command packet transmitted through a network from a remote management server;
a remote management broadcast data generator configured to receive the job control command packet from the communication unit and to generate broadcast data including a job control command included in the job control command packet; and
a broadcast data transmitter configured to receive the broadcast data from the remote management broadcast data generator and to transmit the broadcast data.

10. The data broadcasting apparatus of claim 9, wherein the remote management broadcast data generator comprises:
a job control command packet extractor configured to receive the job control command packet from the communication unit and to extract the job control command; and
a broadcast data converter configured to receive the job control command from the job control command packet extractor and to convert the job control command into the broadcast data.

11. The data broadcasting apparatus of claim 10, wherein the job control command packet extractor embeds position information of the remote management server into the extracted job control command and then outputs the job control command to the broadcast data converter.

12. A remote management target device comprising:
a broadcast data receiver configured to receive broadcast data transmitted from a data broadcasting apparatus, the broadcast data including a job control command for remote management;
a broadcast data decoder configured to receive the broadcast data from the broadcast data receiver, to extract a first job control command packet from the broadcast data, and to output the extracted first job control command packet; and
a remote management corresponding unit configured to receive the first job control command packet from the broadcast data decoder and to analyze the first job control command packet.

13. The remote management target device of claim 12, wherein the broadcast data decoder comprises:
a job control command restorer configured to receive the broadcast data from the broadcast data receiver and to restore the job control command;
a job control command packet generator configured to receive the job control command from the job control command restorer and to generate the first job control command packet; and
a job control command execution checker configured to receive the job control command packet from the job control command packet generator, to check whether the job control command needs to be executed, and to output the first job control command packet to the remote management corresponding unit, when the job control command needs to be executed.

14. The remote management target device of claim 13, wherein the job control command restorer restores position information of a remote management server contained in the broadcast data, and outputs the position information to the job control command packet generator, the remote management server remotely managing the remote management target device.

15. The remote management target device of claim 12, wherein when the job control command of the first job control command packet is a current address checking command to command the remote management target device to report its current network address, the remote management corresponding unit transmits the current network address to a remote management server remotely managing the remote management target device.

16. The remote management target device of claim 12, further comprising a communication unit receiving a second job control command packet to control a job of the remote management target device, the second job control packet being transmitted from a remote management server remotely managing the remote management target device through a network.

17. A remote management method performed by a remote management server connected to a plurality of remote management target devices through a network, the remote management method comprising:
(a) storing in a job table database a plurality of job tables, in which are recorded a plurality of jobs to be executed by one or more of the plurality of remote management target devices;
(b) receiving a job request signal for one or more of the plurality of remote management target devices, generating, when the job is common to a class of the plurality of remote management target devices, a first job description describing the content of a job corresponding to the job request signal and a first control signal, generating, when the job is to be executed individually by one or more remote management target devices of the plurality of remote management target devices, a second job description describing the content of the job and a second control signal, and storing the first job description and the second job description in the job table database;
(c) in response to the first control signal, reading the content of the job described in the first job description from the job table database and generating a first job control command packet; and
(d) in response to the second control signal, reading the content of the job described in the second job description from the job table database and generating a second job control command packet.

18. The remote management method of claim 17, wherein the job table database comprises:
a common job table database storing a plurality of first job descriptions; and
a device job table database storing a plurality of second job descriptions.

19. The remote management method of claim 17, wherein step (b) comprises generating the first job description and the first control signal according to the class of the plurality of remote management target devices.

20. The remote management method of claim 17, wherein step (c) comprises embedding position information of the remote management server into the first job control command packet.

21. The remote management method of claim 17, wherein a job control command written in the first job control command packet is a current address checking command which commands each member of the class of the plurality of remote management target devices to report its current network address.

22. The remote management method of claim 17, further comprising transmitting the first job control command packet to a data broadcast apparatus through the network.

23. The remote management method of claim 17, further comprising:
storing network addresses of the plurality of remote management target devices in a device registration database; and
transmitting the second job control command packet through a second network to at least one remote management target device of the plurality of remote management target devices requested to execute the job,
wherein step (d) comprises transmitting the second job control command packet to the at least one remote management target device with reference to the network addresses of the plurality of remote management target devices stored in the device registration database.

24. The remote management method of claim 19, wherein the class of remote management target devices is defined by one selected from the group consisting of type, manufacturing date, and geographical position information of each remote management target device.

25. A remote management method using a data broadcasting apparatus, the remote management method comprising:
(a) receiving a job control command packet transmitted from a remote management server through a network, the job control command packet transmitted to control a job for a class of a plurality of remote management target devices;
(b) receiving the job control command packet and generating broadcast data, including a job control command included in the job control command packet; and
(c) receiving and transmitting the broadcast data.

26. The remote management method of claim 25, wherein step (b) comprises:
(b1) receiving the job control command packet and extracting the job control command; and
(b2) receiving the extracted job control command and converting the job control command into the broadcast data.

27. The remote management method of claim 26, wherein step (b1) comprises embedding position information of the remote management server into the extracted job control command.

28. A remote management method performed by a remote management target device, the remote management method comprising:
(a) receiving broadcast data transmitted from a data broadcasting apparatus, the broadcast data including a job control command for remote management;
(b) extracting the job control command from the broadcast data, and outputting a first job control command packet; and
(c) analyzing the first job control command packet.

29. The remote management method of claim 28, wherein step (b) comprises:
(b1) processing the broadcast data and restoring the job control command;
(b2) generating the first job control command packet based on the job control command; and
(b3) processing the job control command packet and checking whether the job control command needs to be executed, and
wherein step (c) is performed when the job control command needs to be executed.

30. The remote management method of claim 29, wherein step (b1) comprises restoring position information of a remote management server contained in the broadcast data, the remote management server remotely managing the remote management target device.

31. The remote management method of claim 28, wherein when the job control command of the first job control command packet is a current address checking command to command the remote management target device to report its current network address, step (c) comprises transmitting the current network address to a remote management server remotely managing the remote management target device.

32. The remote management method of claim 28, further comprising receiving a second job control command packet to control a job of the remote management target device, the second job control command packet transmitted through a network from a remote management server remotely managing the remote management target device.

33. A computer readable recording medium in which is recorded a program to perform a remote management method using a remote management server connected to a plurality of remote management target devices, the remote management method comprising:
storing in a job table database a plurality of job tables in which are recorded a plurality of jobs to be executed by one or more remote management target devices of the plurality of remote management target devices;
receiving a job request signal for one or more remote management target devices of the plurality of remote management target devices, generating, when the job is common to a class of the plurality of remote management target devices, a first job description describing the content of a job corresponding to the job request signal and a first control signal, generating, when the job is to be executed individually by one or more of the plurality of remote management target devices, a second job description describing the content of the job and a second control signal, and storing the first job description and the second job description in the job table database;
in response to the first control signal, reading the content of the job described in the first job description from the job table database and generating a first job control command packet; and
in response to the second control signal, reading the content of the job described in the second job description from the job table database and generating a second job control command packet.

34. A computer readable recording medium in which is recorded a program for performing a remote management method using a data broadcasting apparatus, the remote management method comprising:
receiving a job control command packet to control a job of a plurality of remote management target devices, the job control command packet transmitted from a remote management server through a network;
generating broadcast data including a job control command included in the job control command packet; and
transmitting the broadcast data.

35. A computer readable recording medium in which is recorded a program for performing a remote management method using a remote management target device, the remote management method comprising:
receiving broadcast data transmitted from a data broadcasting apparatus, the broadcast data including a job control command for remote management;
extracting a first job control command from the broadcast data, and outputting the extracted first job control command packet; and
analyzing the first job control command packet.
